(19) United States
(12) Patent Application Publication
(10) Pub. No.: US 2008/0120405 A1
(43) Pub. Date: May 22, 2008

(54) APPARATUS AND METHOD FOR SEARCHING/MANAGING HOME NETWORK SERVICE BASED ON HOME NETWORK CONDITION

(76) Inventors: Young-Sung SON, Daejon (KR); Chang-Eun LEE, Daejon (KR); Tai-Yeon KU, Busan (KR); Jun-Hee PARK, Daejon (KR); Dong-Hee KIM, Daejon (KR); Kyeong-Deok MOON, Daejon (KR)

Correspondence Address: LADAS & PARRY LLP, 224 SOUTH MICHIGAN AVENUE, SUITE 1600, CHICAGO, IL, 60604, US

(21) Appl. No.: 11/943,066

(22) Filed: Nov. 20, 2007

(30) Foreign Application Priority Data
Nov. 21, 2006 (KR) 10-2006-0115184

(51) Int. Cl. G06F 15/16

(52) U.S. Cl. 709/223

(57) ABSTRACT

Provided are an apparatus and a method for searching/managing a home network service based on a home network condition. The apparatus, includes: a service storing unit for storing a home network service; a device information analyzing unit for analyzing home network device information and checking a type of the home network device information; a service searching unit for searching a related home network service list according to the type of the home network device information in the home network service list; and a service operation managing unit for installing the home network service upon installation request of the user in the list of the searched home network service, and managing an operation of the home network service upon operation request of the user in the list of the installed home network service.

### CROSS-REFERENCE(S) TO RELATED APPLICATIONS

The present invention claims priority of Korean Patent Application No. 10-2006-0115184, filed on Nov. 21, 2006, which is incorporated herein by reference.

### BACKGROUND OF THE INVENTION

1. Field of the Invention

The present invention relates to an apparatus and method for searching/managing a home network service based on a home network condition; and, more particularly, to an apparatus and method for searching/managing a home network service based on a home network condition which can exactly provide a home network service based on home network device information by searching a home network service list according to a type of home network device information acquired from a home network device, installing the home network service upon request of a user, and managing an operation of the installed home network service.

This work was supported by the IT R&D program for MIC/IITA [2006-S-066-01, “Development of High Reliable Adaptive Middleware for u-Home”].

2. Description of Related Art

Conventional home network service providing technologies include a technology for installing/managing an application in a home network, an Open Service Gateway initiative (OSGi) service platform, and a service technology using the OSGi service platform. Hereinafter, the related art and a problem of the related art will be described.

The technology for installing/managing the application in the home network can dynamically extend a function of a P-controller in a home network environment by continuously updating an application. The related art provides a middleware service for loading a frame work capable of generally supporting diverse home network middlewares in an application server, which is a controller, and accessing and Internet access service and diverse devices in the frame work in a bundle. Accordingly, the related art may remotely update an installed service with no regard to hardware, a network protocol, and an operation system in a home network environment, or easily install/manage the application.

However, since the related art remotely updates the home network service, but does not consider a home network state, it is difficult to provide an exact service to the user by searching a service proper to the home network state.

Another conventional OSGi service platform and the service technology using the conventional OSGi service platform uses an external web service instead of installing the home network service in the home server. When a service is formed in a web service format in the outside of home, the related art does not install the service in the home server on the home network. The related art provides the home network service by cooperating an active service through a remote operation and uses a service required from the home server by importing the service from the web service server. This is for providing the home network service, just as the service is operated in the inside of the home network.

The related art manages the home network service by setting up the home network service in advance and checks only state information of the home network device related to a specific home network service. However, the related art does not generally manage the home network service according to change of the home network device.

### SUMMARY OF THE INVENTION

An embodiment of the present invention is directed to providing an apparatus and method for searching/managing a home network service based on a home network condition which can exactly provide a home network service based on home network device information by searching a home network service list according to a type of home network device information acquired from a home network device, installing the home network service upon request of a user, and managing an operation of the installed home network service.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an apparatus for searching/managing a home network service based on a home network condition, including: a service storing unit for storing a home network service related to home network device information; a device information analyzing unit for analyzing home network device information acquired from a home network device and checking a type of the home network device information; a service searching unit for searching a related home network service list according to the type of the home network device information in the home network service list stored in the service storing unit on the basis of the type of the checked device state information; and a service operation managing unit for installing the home network service upon installation request of the user in the list of the searched home network service, and managing an operation of the home network service upon operation request of the user in the list of the installed home network service.

In accordance with another aspect of the present invention, there is provided a method for searching/managing a home network service based on a home network condition, including the steps of: a) acquiring home network device information from a home network device; b) analyzing the acquired home network device information and checking a type of the device state information; c) searching a related home network service list according to the type of the home network device information in the pre-stored home network service list on the basis of the type of the checked device state information; d) installing the home network service upon installation request of the user in the list of the searched home network service; and e) managing the operation of the home network service upon operation request of the user in the list of the installed home network service.

### BRIEF DESCRIPTION OF THE DRAWINGS

FIG. 1 is a block diagram showing a home network system to which the present invention is applied.

FIG. 2 shows a relation between a home network device and a home network service applied to the present invention.

FIG. 3 is a block diagram showing a home network service search/operation manager based on a home network condition.

FIG. 4 shows a procedure that a new home network device applied to the present invention is installed and a home network service related to the device is installed.

FIG. 5 shows an operation procedure of the home network service related to the home network device applied to the present invention.

FIG. 6 shows a procedure that new device state information applied to the present invention is generated and the home network service related to the device state information is installed.

FIG. 7 shows an operation procedure of the home network service related to the device state information applied to the present invention.

FIG. 8 is a flowchart describing a home network service search/operation managing method based on a home network condition in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

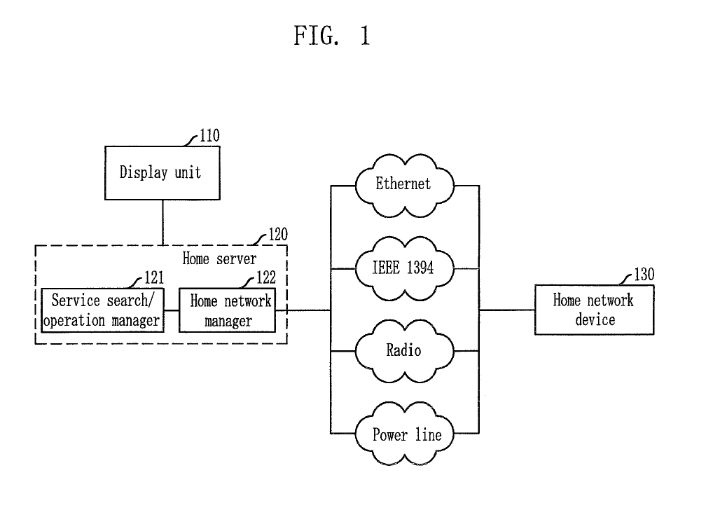

FIG. 1 is a block diagram showing a home network system to which the present invention is applied.

Referring to FIG. 1, the home network system includes a display unit 110, a home server 120, and a home network device 130. The home server 120 includes a service search/operation manager 121 and a home network manager 122.

The display unit 110 provides lists of device information of a home network environment transmitted from the home server 120, the home network device 130 installed at a home network, and a home network service to the user.

The service search/operation manager 121 searches a home network service based on device information collected from the home network device 130, and manages an operation of the searched home network service. The home network manager 122 manages a home network environment, e.g., Ethernet, IEEE 1394, a radio, and a power line, and transmits device information of the home network environment to the service search/operation manager 121.

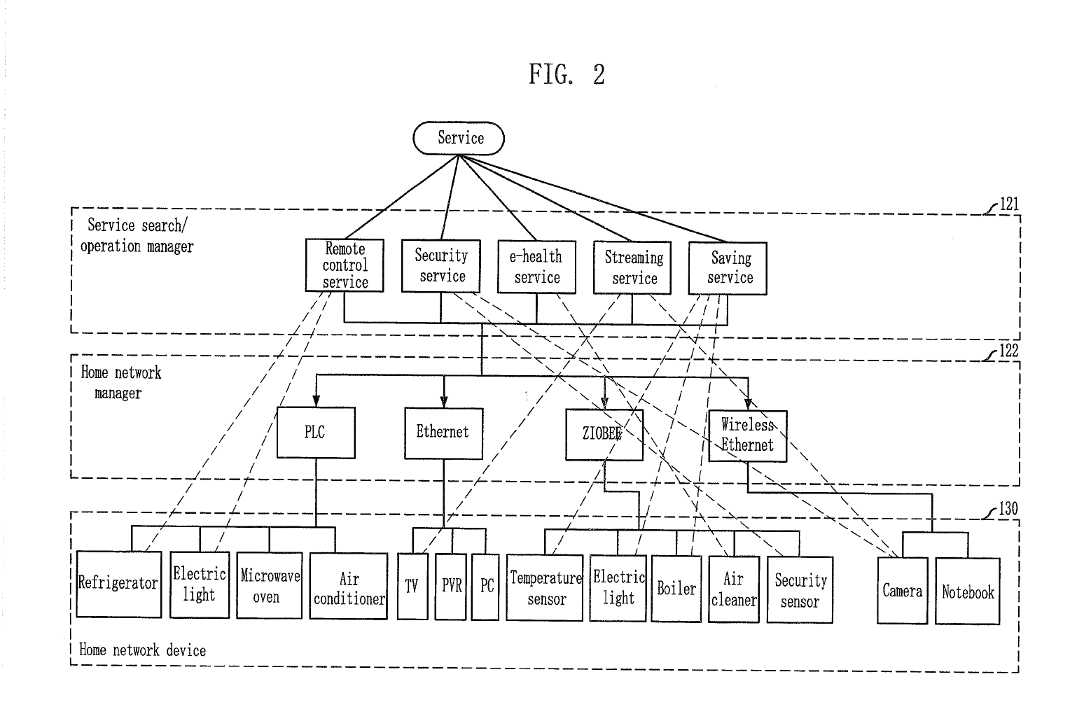

FIG. 2 shows a relation between the home network device and the home network service applied to the present invention.

Referring to FIG. 2, the home network service is provided through the service search/operation manager 121 for managing the operation of the home network service, the home network manager 122 for managing the home network, and the home network device 130. For example, the home network service includes a remote control service, a security service, an e-health service, a streaming service and a saving service.

The home network device 130 can be used in a plurality of home network services. The home network service is related to a plurality of home network devices 130. For example, the home network device 130 such as a temperature sensor, an electric light, and a boiler is used to the saving service using a ZigBee wireless communication. A relationship between the home network device 130 and the home network service is marked as a dotted line in FIG. 2.

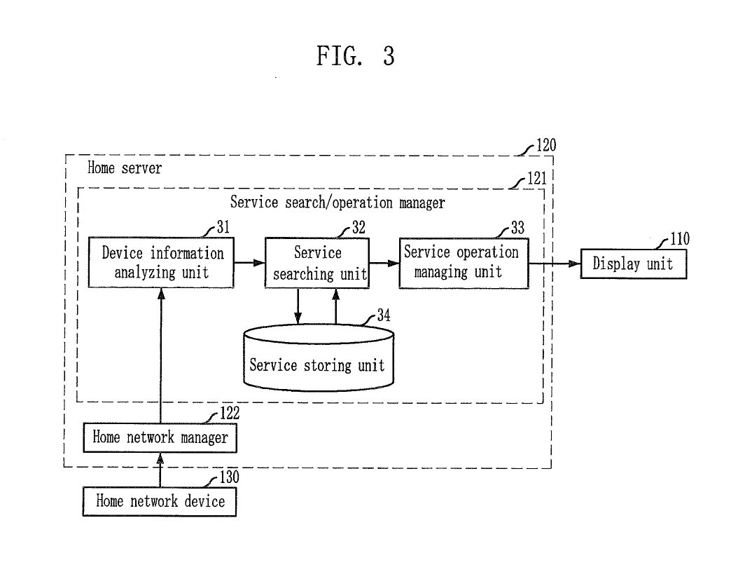

FIG. 3 is a block diagram showing the home network service search/operation manager based on a home network condition.

Referring to FIG. 3, the service search/operation manager 121 includes a device information analyzing unit 31, a service searching unit 32, a service operation managing unit 33, and a service storing unit 34.

The service storing unit 34 stores a list of the home network service related to the home network device 130. The home network service list is pre-stored, or the stored home network service list can be periodically updated through a network or an Internet. The device information analyzing unit 31 analyzes device information transmitted from the home network device 130 through the home network manager 122. The device information analyzing unit 31 grasps a type of the device information and transmits an analysis result to the service searching unit 32. The type of the device information is divided into device installation information and device state information. The device installation information is related to a specific device function of the home network device 130 as well as installing a module of the home network device 130 connected to a home network. Also, device state information means state information controllable by the home network device 130.

The service searching unit 32 searches the home network service based on the result analyzed in the device information analyzing unit 31. That is, the service searching unit 32 searches the home network service related to the home network device 130 or device state information in the home network service stored in the service storing unit 34. The service searching unit 32 transmits the searched home network service to the service operation managing unit 33.

The service operation managing unit 33 manages the home network service list transmitted from the service searching unit 32 and the operation of the home network service according to selection of the user or a pre-determined rule. The service operation managing unit 33 transmits the home network service list to the display unit 110 in order to provide the home network service list to the user. Subsequently, the display unit 110 displays a home network device list with the searched service list.

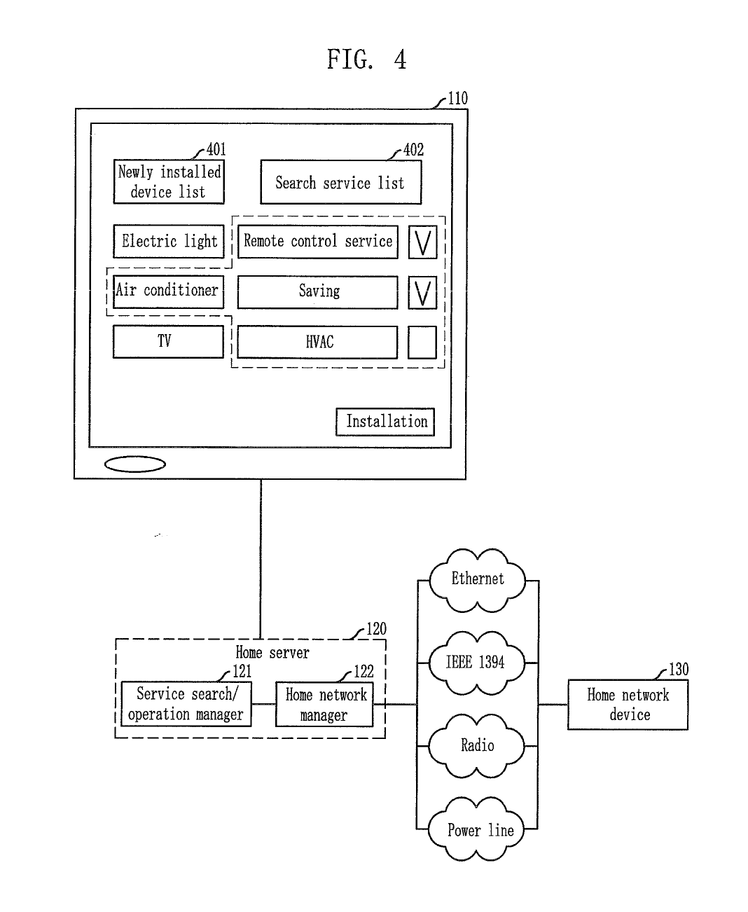

A procedure of searching/operating the home network service based on installation of a new device or new device state information will be described with reference to FIGS. 4 to 7.

FIG. 4 shows a procedure that a new home network device applied to the present invention is installed and the home network service related to the device is installed.

When the home network device 130 is connected to the home network, device installation information on the new home network device 130 is generated. The device installation information is transmitted to the service search/operation manager 121 after passing the home network manager 122 through a home network. The service search/operation manager 121 checks whether the device installation information is new device installation information. When it is checked that the device installation information is new device installation information, the new home network device 130 is installed. Subsequently, the service search/operation manager 121 searches the home network service related to the newly installed home network device 130. The service search/operation manager 121 transmits the list of the newly installed home network device 130 and the searched home network service list to the display unit 110. The display unit 110 displays a newly installed device list 401 and a search service list 402 to the user.

A screen displaying the newly installed device list 401 and the search service list 402 to the user is shown in FIG. 4. A case that an air conditioner is selected in the newly installed device list 401 will be described as an example. When the user selects an air conditioner among an electric light, an air conditioner, and TV in the newly installed device list, the display unit 110 displays the search service list 402 related to the air conditioner transmitted from the service search/operation manager 121. The display unit 110 displays each of a pre-installed service list such as remote control and saving, and non-installed service list Headwaters Action Video Collective (HAVC) in the search service list 402. When the user requests installing of a non-installed HVAC service, the service search/operation manager 120 may install the HAVC service in the search service list 402 upon request of the user.

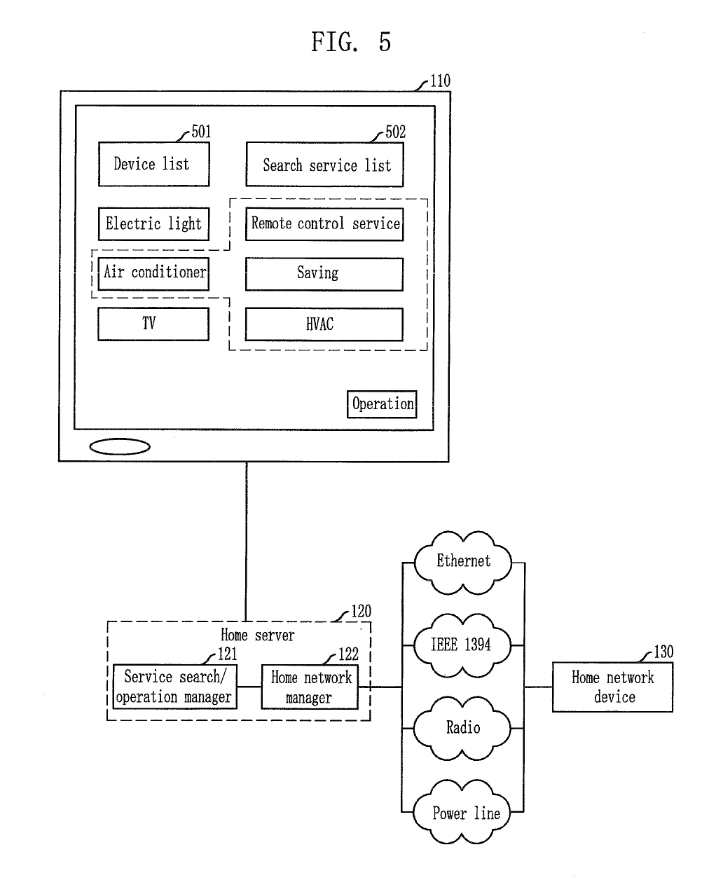

FIG. 5 shows an operation procedure of the home network service related to the home network device applied to the present invention.

As described above, the service search/operation manager 120 installs the HAVC service related to the air conditioner. Referring to FIG. 5, an operation procedure of the home network service related to the home network device will be described.

For example, the user selects the air conditioner in a device list 501 displayed in the display unit 110. Subsequently, the service search/operation manager 121 displays the remote control, the saving, and the HVAC service, which is a currently installed search service list 502 related to the air conditioner through the display unit 110, to the user. The service search/operation manager 121 manages the operation of the remote control, the saving, and the HVAC service in the installed search service list 502 upon request of the user according to the predetermined rule.

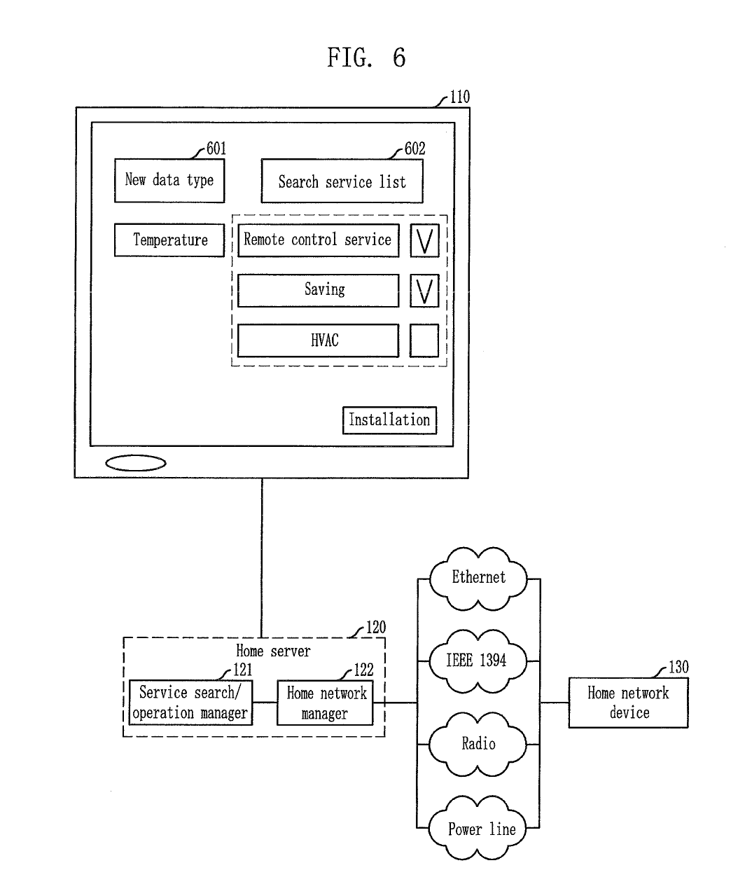

FIG. 6 shows a procedure that new device state information applied to the present invention is generated and the home network service related to the device state information is installed.

When the home network device 130 transmits device state information to the service search/operation manager 121, the device state information is transmitted to the service search/operation manager 121 through the home network manager 122. When the new device state information is checked, the service search/operation manager 121 searches the home network service related to the new device state information. When there is no service related to the new device state information in the pre-stored home network service list, the service search/operation manager 121 can download the service related to the new device state information through a network or an Internet connected to the home server 120. The service search/operation manager 121 transmits each of a type 601 of the new device state information and a searched home network service list 602 to the display unit 110.

A screen displaying the type 601 of the new device state information and the search service list 602 to the user is shown in FIG. 6. For example, when the home network device 130 notifies temperature information to the user in a type of new device state information, the user can check the search service list 602 searched in the service search/operation manager 121 related to the temperature information in the display unit 110. The display unit 110 displays the pre-installed service list such as remote control and saving and non-installed service list HVAC in the search service list 602. When the user requests installing of the HAVC service, the service search/operation manager 120 can install the HAVC service in the search service list 402.

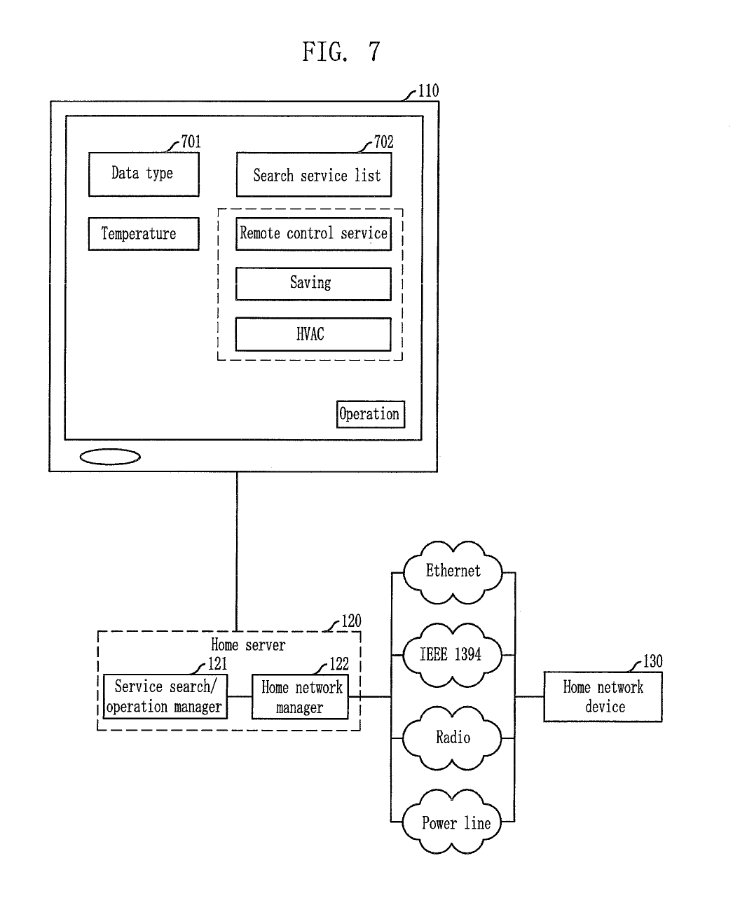

FIG. 7 shows an operation procedure of the home network service related to the device state information applied to the present invention.

As described above, the service search/operation manager 120 installs the HAVC service related to the temperature information. An operation procedure of the home network service related to the temperature information will be described with reference to FIG. 7.

For example, the user selects the temperature information in a type 701 of the device state information displayed in the display unit 110. Subsequently, the service search/operation manager 121 displays remote control, saving, and an HVAC service in a currently installed search service list 702, which is related to temperature information, to the user through the display unit 110. The service search/operation manager 121 manages the operation of the remote control, the saving, and the HVAC service in the installed search service list 702 upon request of the user or a pre-determined rule.

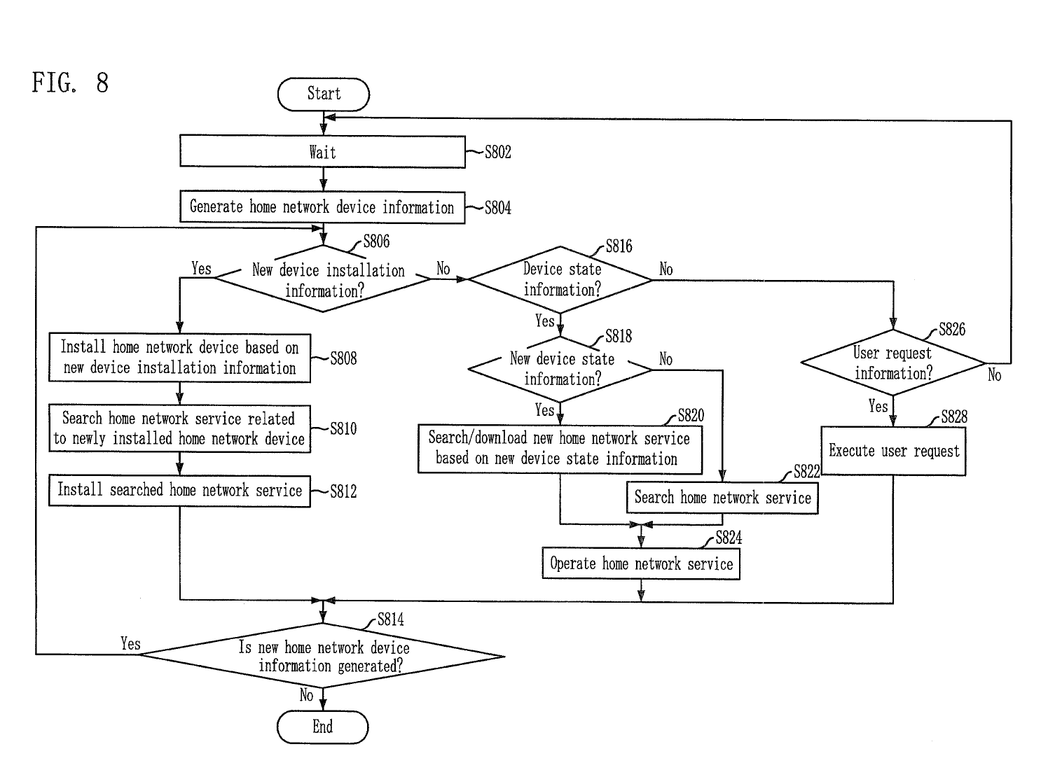

FIG. 8 is a flowchart describing a home network service search/operation managing method based on a home network condition in accordance with an embodiment of the present invention.

The service search/operation manager 121 maintains a waiting state after initializing a system at step S802. When home network device information is generated from the home network device 130 at step S804, the service search/operation manager 121 checks at step S806 whether the home network device information is new device installation information.

When it turns out at step S806 that the home network device information is new device installation information, the service search/operation manager 121 installs the home network device 130 based on the new device installation information at step S808. The service search/operation manager 121 searches a home network service related to the newly installed home network device at step S810. The service search/operation manager 121 installs the home network service searched at the step S810 upon request of the user at step S812.

When it turns out at the step S806 that the home network device information is not new device installation information, the service search/operation manager 121 checks at step S816 whether the home network device information is device state information.

When it turns out at the step S816 that the home network device information is device state information, the service search/operation manager 121 checks at step S818 whether the home network device information is new device state information. When it turns out at the step S818 that the home network device information is the new device state information, the service search/operation manager 121 searches/downloads the new home network service based on the new device state information at step S820. When there is no new home network service matching with the new device state information, the service search/operation manager 121 can download the new home network service matching with the new device state information through a network or an Internet. When the home network device information is not new device state information, the service search/operation manager 121 searches a pre-stored home network service at step S822. The service search/operation manager 121 manages the operation of the home network service searched at the steps S820 or S822 at step S824.

When it turns out at step S816 that the home network device information is not device state information, it is checked at step S826 whether the home network device information is user request information. When the home network device information is the user request information, the service search/operation manager 121 executes the request at step S828. When the home network device information is not the user request information, the logic flow goes to the step S802.

The service search/operation manager 121 performs the procedures of the step S812 or S824, and checks at step S814 whether other home network device information is generated. When it turns out at step S814 that new home network device information is generated, the logic flow goes to the step S806. When new home network device information is not generated, the logic flow goes to the end.

The present invention can provide a service list corresponding to a home network environment to the user and support selecting of an exact service by acquiring state information of a device from a plurality of home network devices in a home network environment, dynamically searching a service related to the device state information, and controlling installation/operation of the searched service.

The present invention can add a new home network device after installing the home network device and service, or update a function of a pre-installed home network device. Also, the home network device and the service can be dynamically connected by overcoming a conventional method, by which the added device and device function cannot be used.

The present invention can quickly/easily maintain and repair the home network by receiving device state information from the device in the home network environment.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

While the present invention has been described with respect to the specific embodiments, it will be apparent to those skilled in the art that various changes and modifications may be made without departing from the spirit and scope of the invention as defined in the following claims.

What is claimed is:

1. An apparatus for searching/managing a home network service based on a home network condition, comprising:
a service storing means for storing a home network service related to home network device information;
a device information analyzing means for analyzing home network device information acquired from a home network device and checking a type of the home network device information;
a service searching means for searching a related home network service list according to the type of the home network device information in the home network service list stored in the service storing means on the basis of the type of the checked device state information; and
a service operation managing means for installing the home network service upon installation request of the user in the list of the searched home network service, and managing an operation of the home network service upon operation request of the user in the list of the installed home network service.

2. The apparatus of claim 1, further comprising:
a display means for displaying the searched home network service list to the user and receiving the installation and operation requests of the home network service from the user.

3. The apparatus of claim 1, wherein the service storing means updates a pre-stored home network service list through a wired/wireless network.

4. The apparatus of claim 3, wherein when the type of the checked home network device information is device installation information, the service searching means searches a home network service related to the newly installed home network device after installation of the home network device, and divides the searched home network service list into a pre-installed home network service list and a non-installed home network service list, and transmits each of the pre-installed home network service list and the non-installed home network service list to the display means.

5. The apparatus of claim 3, wherein when the type of the checked home network device information is device state information, the service searching means searches a new home network service based on new device state information, and divides the searched home network service list into a pre-installed home network service list and a non-installed home network service list, and transmits each of the pre-installed home network service list and the non-installed home network service list to the display means.

6. A method for searching/managing a home network service based on a home network condition, comprising the steps of:
a) acquiring home network device information from a home network device;
b) analyzing the acquired home network device information and checking a type of the device state information;
c) searching a related home network service list according to the type of the home network device information in the pre-stored home network service list on the basis of the type of the checked device state information;
d) installing the home network service upon installation request of the user in the list of the searched home network service; and
e) managing the operation of the home network service upon operation request of the user in the list of the installed home network service.

7. The method of claim 6, further comprising the step of:
f) displaying the searched home network service list to the user and receiving installation and operation request of the home network service from the user.

8. The method of claim 6, wherein in the step c), the pre-stored home network service list is updated through a wired/wireless network, and a related home network service list is searched according to the type of the home network device information in the updated home network service list.

9. The method of claim 8, wherein in the step c), when the type of the checked home network device information is device installation information and the home network device is installed, a home network service related to the newly installed home network device is searched and the searched home network service list is divided into a pre-installed home network service list and a non-installed home network service list and displayed to the user.

10. The method of claim 8, wherein in the step c), when the type of the checked home network device information is device state information, a new home network service is searched based on the new device state information and the searched home network service list is divided into a pre-installed home network service list and a non-installed home network service list and displayed to the user.
